(19) United States
(12) Patent Application Publication
(10) Pub. No.: US 2013/0130087 A1
(43) Pub. Date: May 23, 2013

(54) NON-AQUEOUS ELECTROLYTE BATTERY MODULE

(71) Applicants: Hitoshi Kawaguchi, Ashigarakami-gun (JP); Ryozo Yoshino, Ashigarakami-gun (JP); Yuji Kodera, Ibaraki-shi (JP); Koichi Kajiyama, Ibaraki-shi (JP)

(72) Inventors: Hitoshi Kawaguchi, Ashigarakami-gun (JP); Ryozo Yoshino, Ashigarakami-gun (JP); Yuji Kodera, Ibaraki-shi (JP); Koichi Kajiyama, Ibaraki-shi (JP)

(73) Assignee: HITACHI, LTD., Tokyo (JP)

(21) Appl. No.: 13/812,085

(22) PCT Filed: Jun. 28, 2012
(86) PCT No.: PCT/JP2012/066595

§ 371 Date: Jan. 24, 2013

(30) Foreign Application Priority Data
Jul. 5, 2011 (JP) 2011-149006

(51) Int. Cl. H01M 10/50

(52) U.S. Cl. CPC H01M 10/5032
USPC 429/120

(57) ABSTRACT

A non-aqueous electrolyte battery module of the invention includes: a plurality of non-aqueous electrolyte batteries, a plurality of heat dissipating members, a plurality of heat insulating members, and an exterior casing housing the non-aqueous electrolyte batteries, the heat dissipating members and the heat insulating members, the non-aqueous electrolyte batteries each includes a battery element and a flexible exterior member housing the battery element, the non-aqueous electrolyte batteries are laminated with the heat dissipating members interposed therebetween to form a battery laminate, ends of the heat dissipating members are in tight pressing contact with an inner face of the exterior casing, and the heat insulating members are disposed between the exterior casing and opposite ends of the battery laminate in a laminating direction thereof.

### TECHNICAL FIELD

The present invention relates to a non-aqueous electrolyte battery module including a flexible exterior member.

### BACKGROUND ART

Non-aqueous electrolyte batteries, as typified by lithium ion secondary batteries, are characterized by having high energy density, and thus are widely used as power sources for portable devices, including, for example, mobile phones and notebook personal computers. The capacity of lithium ion secondary batteries is likely to increase further as the performance of portable devices is enhanced. Accordingly, flat-type non-aqueous electrolyte batteries using a flexible laminate exterior member are often used in order to further increase the energy density.

Meanwhile, with the recent enhancement of the performance of non-aqueous electrolyte batteries, non-aqueous electrolyte batteries have begun to be used as power sources other than those for portable devices. For example, non-aqueous electrolyte batteries have begun to be used also as power sources for automobiles and motorcycles, and power sources for moving objects such as robots.

In the case of using non-aqueous electrolyte batteries as power sources for automobiles and motorcycles, and power sources for moving objects such as robots, a plurality of non-aqueous electrolyte batteries are combined to form a module in order to further increase the capacity. When non-aqueous electrolyte batteries are used as a module in this manner, it is difficult to disperse the heat generated from the non-aqueous electrolyte batteries to the outside during charging and discharging, and therefore it is necessary to increase the heat dissipation from the non-aqueous electrolyte batteries.

Furthermore, in investigating how to improve heat dissipation of a non-aqueous electrolyte battery module, it is necessary to consider not only the heat dissipation from each of the non-aqueous electrolyte batteries, but also the heat dissipation balance among the non-aqueous electrolyte batteries constituting the non-aqueous electrolyte battery module. This is because a heat dissipation imbalance among the non-aqueous electrolyte batteries causes temperature differences among the non-aqueous electrolyte batteries, resulting in an imbalance in charge/discharge characteristics among the non-aqueous electrolyte batteries.

As an example of the measures for dealing with the heat dissipation of a battery module, Patent Document 1 discloses a battery module in which an assembled battery formed by housing, in a case, a plurality of laminated flat-type batteries each internally including a power generating element sealed by an exterior member, and a bent portion formed by bending the peripheral portion of the exterior member in the laminating direction of the flat-type batteries is abutted against the inner face of the case.

### PRIOR ART DOCUMENTS

### Patent Document

[Patent Document 1] JP 2006-172911A

### DISCLOSURE OF INVENTION

### Problem to be Solved by the Invention

However, there is the possibility that sufficient heat dissipation is not achieved according to Patent Document 1 because heat dissipation is carried out by abutting the peripheral portion of the exterior member, whose heat conductivity does not seem to be very high, against the inner face of the case. Moreover, according to Patent Document 1, the bent peripheral portion of the exterior member is merely abutted against the inner face of the case, and therefore there is the possibility that the exterior member may not be sufficiently pressed against the bent portion, resulting in insufficient heat dissipation. Moreover, Patent Document 1 considers the heat dissipation of individual batteries, but does not consider the heat dissipation balance among the batteries. Accordingly, even if the heat dissipation advances to some degree, there is risk of a temperature imbalance among the batteries.

The present invention solves the above-described problem, and provides a non-aqueous electrolyte battery module having high heat dissipation properties even when the temperatures of batteries and the battery module are high, and exhibiting an excellent heat dissipation balance among the batteries.

### Means for Solving Problem

A non-aqueous electrolyte battery module of the present invention is a non-aqueous electrolyte battery module including: a plurality of non-aqueous electrolyte batteries, a plurality of heat dissipating members, a plurality of heat insulating members, and an exterior casing housing the non-aqueous electrolyte batteries, the heat dissipating members and the heat insulating members, the non-aqueous electrolyte batteries each including a battery element and a flexible exterior member housing the battery element, the non-aqueous electrolyte batteries being laminated with the heat dissipating members interposed therebetween to form a battery laminate, ends of the heat dissipating members being in tight pressing contact with an inner face of the exterior casing, the heat insulating members being disposed between the exterior casing and opposite ends of the battery laminate in a laminating direction thereof.

### Effects of the Invention

According to the present invention, it is possible to provide a non-aqueous electrolyte battery module having high heat dissipation and exhibiting an excellent heat dissipation balance among batteries.

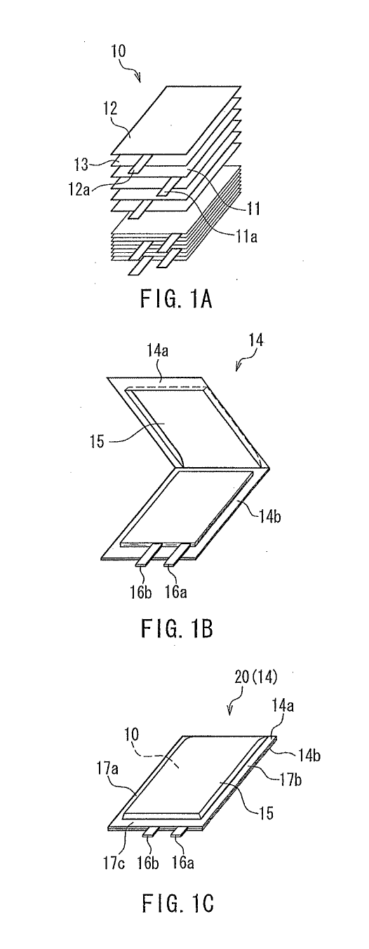

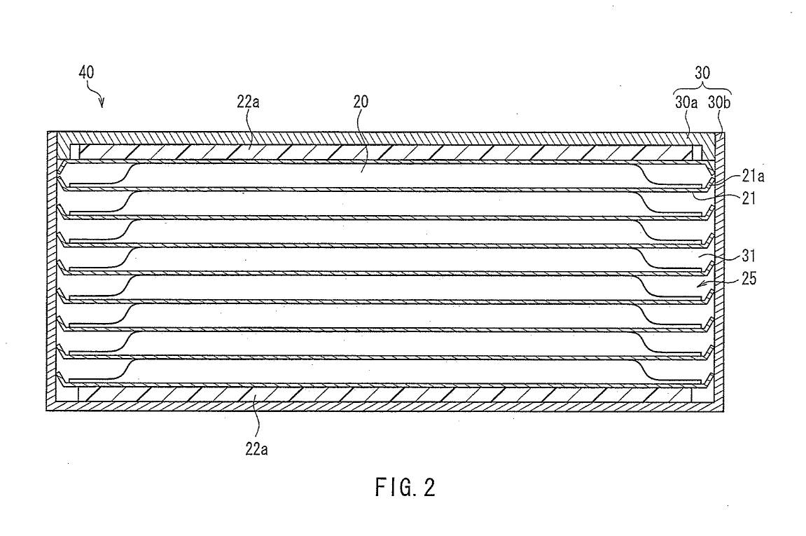

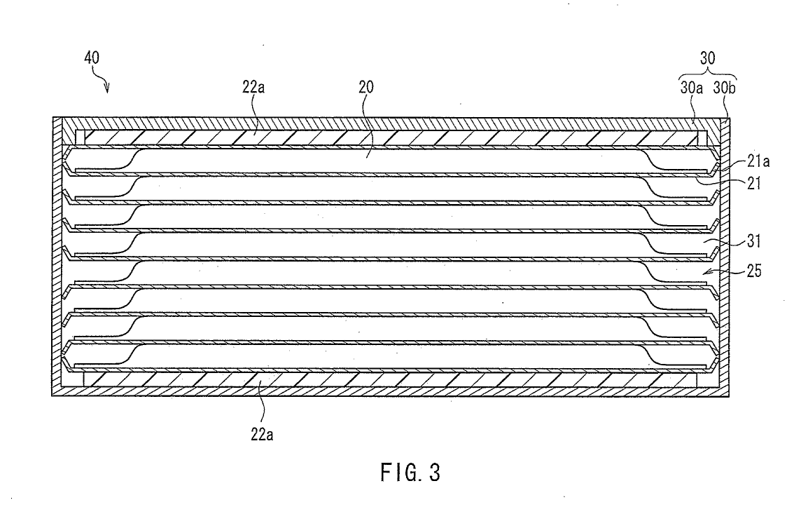

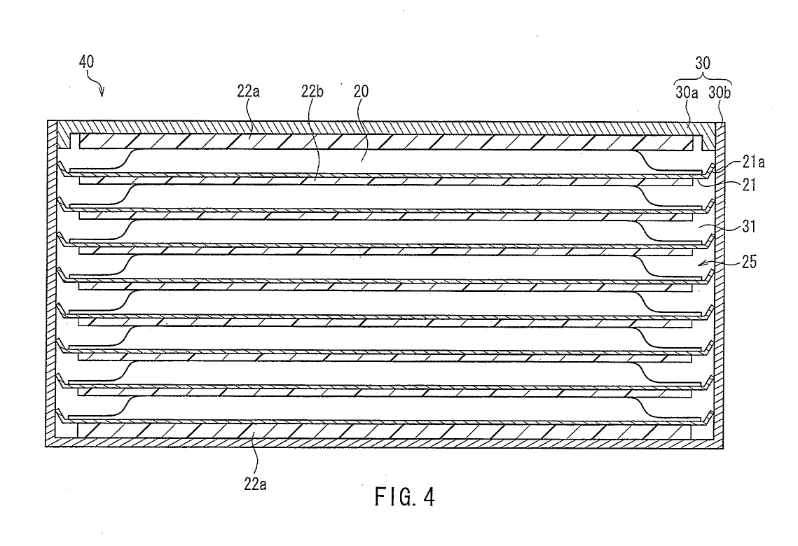

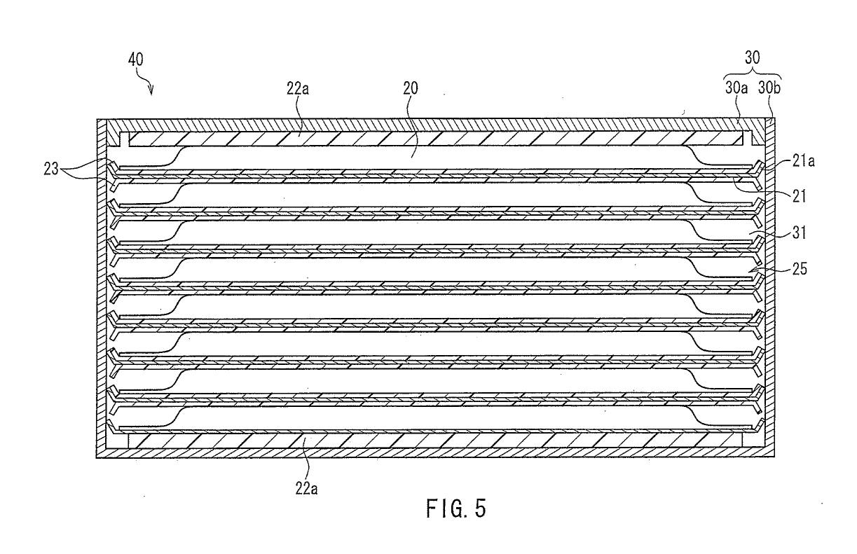

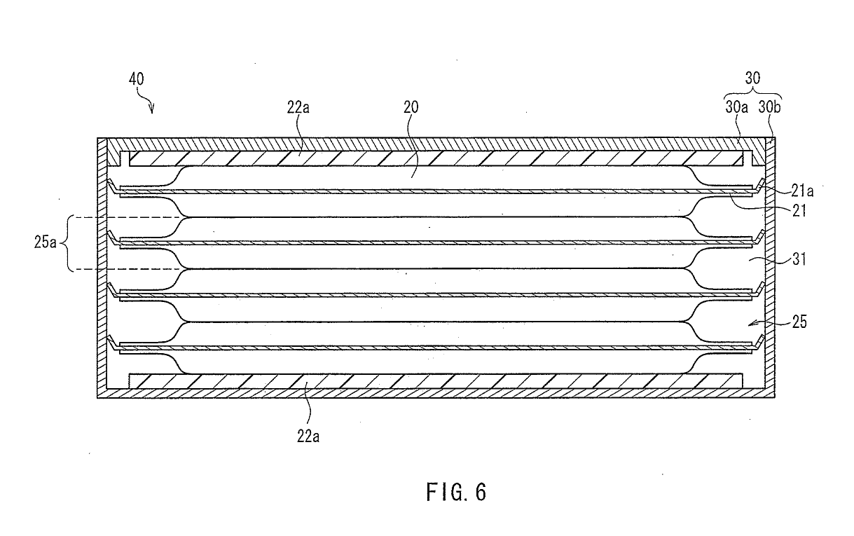

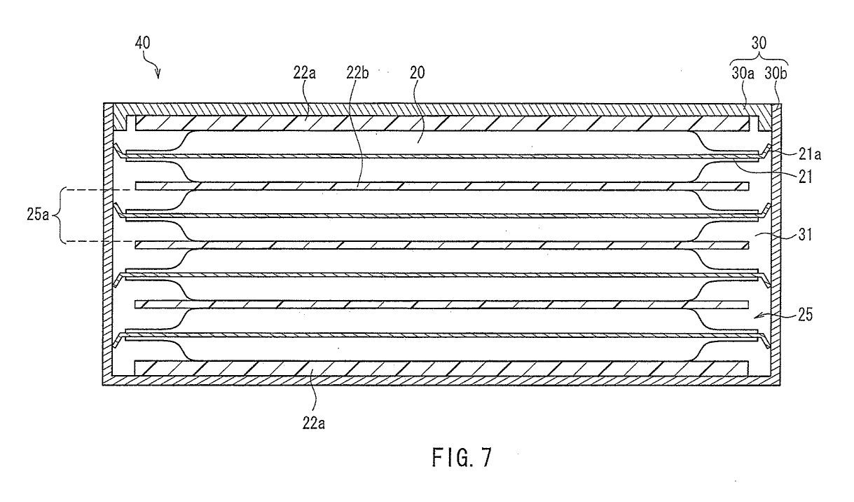

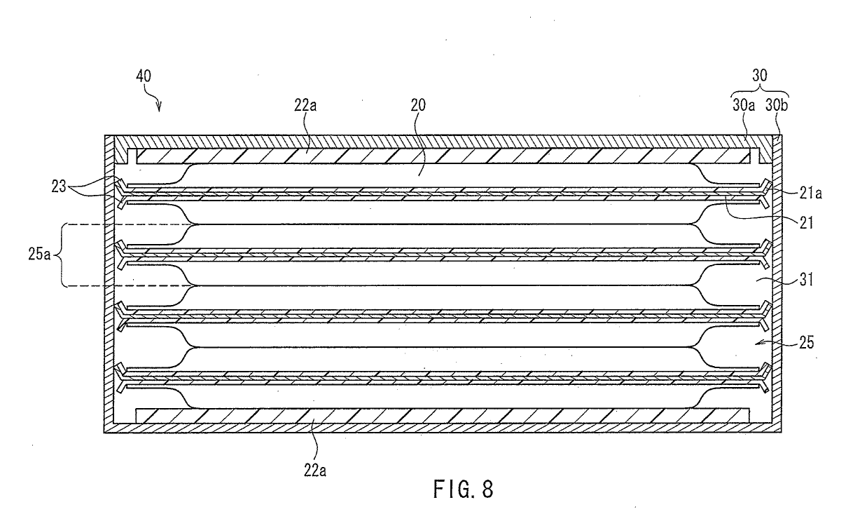

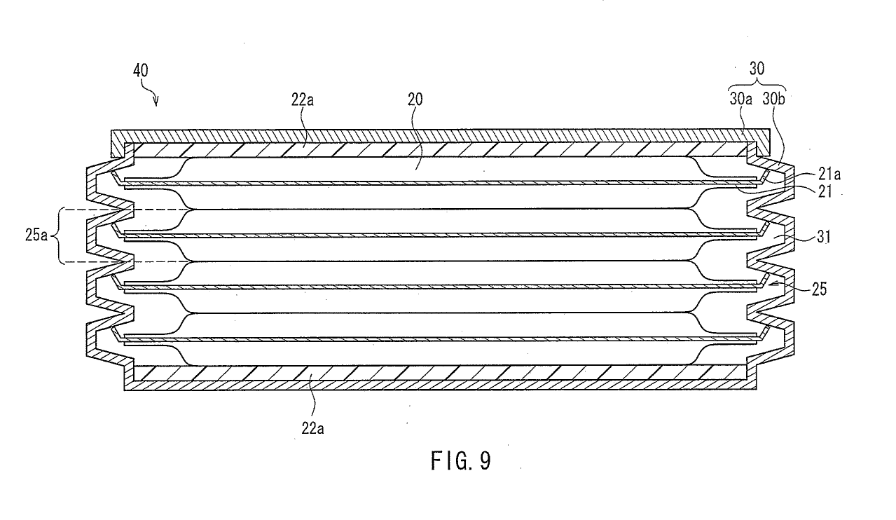

### BRIEF DESCRIPTION OF DRAWINGS

[FIG. 1] FIG. 1A is a perspective view for illustrating an electrode assembly used in the present invention, FIG. 1B is a perspective view showing a state in which the electrode assembly is being housed in an exterior member, and FIG. 1C is a perspective view showing a state in which the electrode assembly has been housed in the exterior member to complete a flat-type lithium ion secondary battery.

[FIG. 2] FIG. 2 is a cross-sectional view of a non-aqueous electrolyte battery module according to the present invention.

[FIG. 3] FIG. 3 is a cross-sectional view showing another mode of the non-aqueous electrolyte battery module according to the present invention.

[FIG. 4] FIG. 4 is a cross-sectional view showing yet another mode of the non-aqueous electrolyte battery module according to the present invention.

[FIG. 5] FIG. 5 is a cross-sectional view showing yet another mode of the non-aqueous electrolyte battery module according to the present invention.

[FIG. 6] FIG. 6 is a cross-sectional view showing yet another mode of the non-aqueous electrolyte battery module according to the present invention.

[FIG. 7] FIG. 7 is a cross-sectional view showing yet another mode of the non-aqueous electrolyte battery module according to the present invention.

[FIG. 8] FIG. 8 is a cross-sectional view showing yet another mode of the non-aqueous electrolyte battery module according to the present invention.

[FIG. 9] FIG. 9 is a cross-sectional view showing yet another mode of the non-aqueous electrolyte battery module according to the present invention.

### DESCRIPTION OF THE INVENTION

A non-aqueous electrolyte battery module according to the present invention includes: a plurality of non-aqueous electrolyte batteries, a plurality of heat dissipating members, a plurality of heat insulating members, and an exterior casing housing the non-aqueous electrolyte batteries, the heat dissipating members and the heat insulating members. The non-aqueous electrolyte batteries each includes a battery element and a flexible exterior member housing the battery element, and the non-aqueous electrolyte batteries are laminated with the heat dissipating members interposed therebetween to form a battery laminate. Furthermore, ends of the heat dissipating members are in tight pressing contact with an inner face of the exterior casing, and the heat insulating members are disposed between the exterior casing and opposite ends of the battery laminate in a laminating direction thereof.

Since the non-aqueous electrolyte battery module of the present invention includes the heat dissipating members coming into tight pressing contact with the inner face of the exterior casing, the heat dissipating members are sufficiently pressed against the inner face of the exterior casing. Accordingly, the heat that has been conducted from the non-aqueous electrolyte batteries can be conducted efficiently from the heat dissipating members to the exterior casing, thus achieving heat dissipation.

Further, with the non-aqueous electrolyte battery module of the present invention, the heat insulating members are disposed between the exterior casing and opposite ends of the battery laminate in the laminating direction thereof, and therefore, the heat dissipation of the non-aqueous electrolyte batteries located at the opposite ends, which constitute the battery laminate, does not advance further than the heat dissipation of the other batteries, making it possible to achieve uniform heat dissipation for the non-aqueous electrolyte batteries. Accordingly, it is possible to prevent temperature differences among the non-aqueous electrolyte batteries, thus maintaining uniform charge/discharge characteristics of the batteries.

Preferably, the exterior casing is formed of metal, and the heat dissipating members are each formed of a metal plate. The reason for this is that the heat from the non-aqueous electrolyte batteries can be conducted efficiently to the exterior casing, and that heat can be dissipated from the exterior casing to the outside.

Preferably, the ends of the heat dissipating members include bent portions, and the bending angle of the bent portions is an obtuse angle. By bending the ends of the heat dissipating members made of a metal plate at an obtuse angle, the heat dissipating members are pressed against the inner face of the exterior casing by the toughness of the metal plate, and thereby the ends of the heat dissipating members can be brought into tight pressing contact with the inner face of the exterior casing in a reliable manner.

Hereinafter, an embodiment of the present invention will now be described with reference to the drawings. Note, however, that, in FIGS. 1 to 9, identical portions are denoted by identical reference numerals and any redundant description thereof may be omitted.

First, an embodiment of a non-aqueous electrolyte battery used in the present invention will be described, taking, as an example, a flat-type lithium ion secondary battery. FIG. 1A is a perspective view for illustrating an electrode assembly used in the present embodiment. FIG. 1B is a perspective view showing a state in which the electrode assembly is being housed in an exterior member. FIG. 1C is a perspective view showing a state in which the electrode assembly has been housed in the exterior member to complete a flat-type lithium ion secondary battery.

In FIG. 1A, an electrode assembly 10 included in a battery element is produced by laminating rectangular positive electrodes 11 and rectangular negative electrodes 12, with rectangular separators 13 disposed therebetween. A positive electrode lead terminal 11a is provided at one end of each positive electrode 11, and a negative electrode lead terminal 12a is provided at one end of each negative electrode 12.

In FIG. 1B, a flexible, rectangular exterior member 14 is valley-folded, so that a first exterior surface 14a and a second exterior surface 14b constitute the exterior member 14. The first exterior surface 14a is provided with an electrode housing portion 15 that has been formed by deep-drawing. The positive electrode lead terminals 11a (FIG. 1A) and the negative electrode lead terminals 12a (FIG. 1A) are placed on each other and then welded together to form a positive electrode lead terminal portion 16a and a negative electrode lead terminal portion 16b, respectively.

In FIG. 1C, the electrode assembly 10 is housed together with a non-aqueous electrolyte in the electrode housing portion 15, which is formed by the valley-folded first exterior surface 14a and second exterior surface 14b. Of the peripheral sides of the exterior member 14, three sides other than the valley-folded side are bonded so as to have a predetermined width, thus forming sealing portions 17a, 17b, and 17c. The positive electrode lead terminal portion 16a and the negative electrode lead terminal portion 16b extend to the outside from the sealing portion 17c opposite from the valley-folded side of the exterior member 14. Thus, a non-aqueous electrolyte battery (flat-type lithium ion secondary battery) 20 is completed.

A positive electrode 11 can be formed as follows: a positive electrode material mixture paste, which is obtained by adding a solvent to a mixture containing a positive electrode active material, a positive electrode conductivity enhancing agent, a positive electrode binder and the like, followed by sufficient kneading, is applied onto both faces of a positive electrode current collector, followed by drying, and thereafter the positive electrode material mixture layer is controlled so as to have a predetermined thickness and a predetermined electrode density.

As the above positive electrode active material, a spinel-structured lithium-containing composite oxide containing manganese may be used alone, or a mixture of a spinel-structured lithium-containing composite oxide containing manganese and a different positive electrode active material may be used. The content of the spinel-structured lithium-containing composite oxide containing manganese in the entire positive electrode active material is preferably 70 to 100 mass % in a mass ratio. This is because the positive electrode active material tends to have insufficient thermal stability when the above-described content falls below 70 mass %.

Examples of the spinel-structured lithium-containing composite oxide containing manganese include lithium-containing composite oxides having a composition of the general formula LiₓMn₂O₄ (0.98<x≦1.1) and lithium-containing composite oxides in which Mn in the above general formula is partly substituted with at least one element selected from Ge, Zr, Mg, Ni, Al and Co (e.g., LiCoMnO₄, LiNi_{0.5}Mn_{1.5}O₄, etc.). The spinel-structured lithium-containing composite oxide containing manganese may be used alone or in combination of two or more.

Examples of the different positive electrode active material include layer-structured composite oxides such as lithium cobalt composite oxides as typified by the general formula LiCoO₂ (including composite oxides in which part of the constituent elements is substituted with an element such as Ni, Al, Mg, Zr, Ti, or B), lithium nickel composite oxides as typified by the general formulas LiNiO₂, Li₁₊ₓNi_{0.7}Co_{0.25}Al_{0.05}O₂ or the like (including composite oxides in which part of the constituent elements is substituted with an element such as Co, Al, Mg, Zr, Ti, or B); spinel-structured composite oxides such as lithium titanium composite oxides as typified by the general formula Li₄Ti₅O₁₂ (including composite oxides in which part of the constituent elements is substituted with an element such as Ni, Co, Al, Mg, Zr, or B); and olivine-structured lithium composite oxides as typified by the general formula LiMPO₄ (where M is at least one selected from Ni, Co and Fe).

The positive electrode conductivity enhancing agent may be added as needed for improving the conductivity of the positive electrode material mixture layer, and conductive powder is usually used. For example, carbon powder such as carbon black, ketjen black, acetylene black, fibrous carbon and graphite, and metal powder such as nickel powder can be used as the above-described conductive powder.

Examples of the positive electrode binder include, but are not limited to, polyvinylidene fluoride (PVDF) and polytetrafluoroethylene (PTFE).

There is no particular limitation with respect to the positive electrode current collector, as long as an electron conductor that is substantially chemically stable in the formed battery is used. For example, aluminum foil or the like having a thickness of 10 to 30 μm can be used as the positive electrode current collector.

For example, N-methyl-2-pyrrolidone or the like is used as the above-described solvent.

The thickness of the positive electrode 11 is not particularly limited, but is usually 110 to 230 μm.

A negative electrode 12 can be formed as follows: a negative electrode material mixture paste, which is obtained by adding a solvent to a mixture containing a negative electrode active material, a negative electrode conductivity enhancing agent, a negative electrode binder and the like, followed by sufficient kneading, is applied onto both faces of a negative electrode current collector, followed by drying, and thereafter the negative electrode material mixture layer is controlled so as to have a predetermined thickness and a predetermined electrode density.

For example, a carbon material such as natural graphite or artificial graphite, including, for example, bulk graphite, flake graphite and amorphous graphite can be used as the negative electrode active material. However, the negative electrode active material is not limited to these materials, as long as a material capable of absorbing and desorbing lithium ion is used.

There is no particular limitation with respect to a negative electrode current collector as long as it is an electronic conductor that is substantially chemically stable in the battery formed therewith. For example, copper foil or the like having a thickness of 5 to 20 μm can be used as the negative electrode current collector.

The same materials as those used for the positive electrode can be used for the negative electrode conductivity enhancing agent, the negative electrode binder and the solvent.

The thickness of the negative electrode 12 is not particularly limited, but is usually 65 to 220 μm.

A two-layer structured separator including a heat-resistant porous substrate having a thickness of 10 to 50 μm and a microporous film made of thermoplastic resin having a thickness of 10 to 30 μm can be used as the separator 13. The heat-resistant porous substrate may be formed of, for example, a fibrous material having a heat-resistant temperature of 150° C. or more. The fibrous material can be formed of at least one material selected from cellulose and modified products thereof, and polyolefin, polyester, polyacrylonitrile, aramid, polyamide imide and polyimide. More specifically, a sheet-like material of woven fabric, non-woven fabric (including paper) or the like made of any one of the aforementioned materials can be used as the heat-resistant porous substrate.

Furthermore, in order to provide the separator with the shut-down function of closing micro pores at a predetermined temperature (100 to 140° C.) or more to increase the resistance, a microporous film made of a thermoplastic resin having a melting point of 80 to 140° C. can be used as the microporous film made of a thermoplastic resin. More specifically, it is possible to use a microporous sheet made of an olefin-based polymer, which is resistance to organic solvents and is hydrophobic, such as polypropylene and polyethylene.

The thickness of the separator 13 is not particularly limited to, but is usually 25 to 90 μm.

A laminate film in which a metal layer of aluminum or the like and a thermoplastic resin layer are laminated can be used as the exterior member 14. For example, it is possible to use a laminate film in which a thermoplastic resin layer having a thickness of 20 to 50 μm is provided outside an aluminum layer having a thickness of 20 to 100 μm, and an adhesive layer having a thickness of 20 to 100 μm is provided inside the aluminum layer. This allows the sealing portions 17a, 17b and 17c to be bonded reliably by thermal welding.

The thickness of the exterior member 14 is not particularly limited, but is usually 60 to 250 μm.

A non-aqueous electrolyte in which a lithium salt is dissolved in an organic solvent can be used as the above non-aqueous electrolyte. For example, one or a combination of two or more of organic solvents such as vinylene carbonate (VC), propylene carbonate (PC), ethylene carbonate (EC), butylene carbonate (BC), dimethyl carbonate (DMC), diethyl carbonate (DEC), methyl ethyl carbonate (MEC) and y-butyrolactone can be used as the organic solvent. For example, at least one lithium salt selected from LiClO₄, LiPF₆, LiBF₄, LiAsF₆, LiSbF₆, LiCF₃SO₃ and the like can be used as the aforementioned lithium salt. The Li ion concentration in the non-aqueous electrolyte may be 0.5 to 1.5 mol/L.

Next, an embodiment of the non-aqueous electrolyte battery module of the present invention will now be described. The non-aqueous electrolyte battery module of the present embodiment is formed by inserting, in an exterior casing, a plurality of non-aqueous electrolyte batteries as described above laminated together with heat dissipating members and heat insulating members.

### Embodiment 1

FIG. 2 is a cross-sectional view of a non-aqueous electrolyte battery module according to the present embodiment. In FIG. 2, eight non-aqueous electrolyte batteries 20 that are laminated alternately with heat dissipating members 21 so that the heat dissipating members 21 are disposed therebetween are housed inside an exterior casing 30 of a non-aqueous electrolyte battery module 40. Note that in FIG. 2, the hatching indicating the cross section is omitted for the non-aqueous electrolyte batteries 20 to facilitate understanding of the drawing. The same applies to FIGS. 3 to 9, which will be described below. The non-aqueous electrolyte batteries 20 and the heat dissipating members 21 are alternately laminated and the heat dissipating members 21 are further disposed at opposite ends of the resulting laminated structure, to form a battery laminate 25. Usually, the battery laminate 25 is formed before insertion into the exterior casing 30, and inserted in the exterior casing 30 after the formation. Further, the non-aqueous electrolyte batteries 20 and the heat dissipating members 21 may be laminated by being bonded with an adhesive.

Each heat dissipating member 21 is formed of a metal plate, and its ends are bent at an obtuse angle to form a bent portion 21a. Thereby, the ends of the heat dissipating members 21 can come into tight pressing contact with the inner face of the exterior casing 30 by the toughness of the metal plate, which results in improved heat conduction and improved positional stability of the battery laminate 25. The bent portions 21a may be formed in advance at the time of production of the battery laminate 25. In that case, when the bending directions of the bent portions 21a are all the same, insertion of the battery laminate 25 into the exterior casing 30 can be facilitated. The battery laminate 25 may be formed such that the outer dimension of the heat dissipating members 21 is larger than the inner dimension of the exterior casing 30, and the bent portions 21a may be formed by bending the ends of the heat dissipating members 21 by press-fitting force exerted when the battery laminate 25 is press-fitted into the exterior casing 30. In that case, the bending directions of the bent portions 21a are all the same.

There is no particular limitation with respect to the material of the metal plate forming the heat dissipating members 21 as long as a metal having toughness is used. For example, it is possible to use iron, copper, aluminum, nickel, stainless steel, or the like. There is also no particular limitation with respect to the thickness of the heat dissipating members 21 as long as a thickness that yields the toughness is used. In view of strength and heat conduction, the thickness may be about 0.1 to 3 mm, for example. Furthermore, in view of the weight reduction for the batteries, the thickness may be about 0.1 to 1 mm.

A heat insulating member 22a is disposed between the exterior casing 30 and opposite ends of the battery laminate 25 in the laminating direction. There is no particular limitation with respect to the material of the heat insulating members 22a, as long as a material having high heat insulating properties is used. For example, it is possible to use a thermoplastic resin such as polyethylene (PE), polypropylene (PP) and polyethylene terephthalate (PET) and foamed plastic such as polyurethane foam. When a thermally expandable resin such as PE, PP, polyacetal, polyamide or ABS is used as the material of the heat insulating members 22a, the heat insulating members 22a expand due to the heat generated during the use of the non-aqueous electrolyte battery module 40. This makes it possible to press the battery laminate 25 from above and below, thus improving the contact between the non-aqueous electrolyte batteries 20 and the heat dissipating members 21 and also improving heat dissipation. While there is also no particular limitation with respect to the thickness of the heat insulating member 22a as long as a thickness that can suppress the heat conduction between the non-aqueous electrolyte battery 20 and the exterior casing 30, the thickness may be about 2 to 5 mm, for example.

The exterior casing 30 is formed by a lid portion 30a and a container portion 30b. In order to achieve a balance in heat dissipation and heat insulation in the exterior casing 30 as a whole, the lid portion 30a and the container portion 30b of the exterior casing 30 are preferably made of the same metal. While there is no particular limitation with respect to the metal constituting the exterior casing 30, an aluminum material having high heat conductivity is preferable.

Although a space 31 is formed between a non-aqueous electrolyte battery 20 and the exterior casing 30 in the present embodiment, the space 31 may be filled with a resin. This further improves the positional stability of the battery laminate 25 inside the exterior casing 30 and the heat dissipating properties, thus improving the earthquake resistance and the heat dissipation of the non-aqueous electrolyte battery module 40.

Since the non-aqueous electrolyte battery module 40 of the present embodiment includes heat dissipating members 21 coming into tight pressing contact with the inner face of the exterior casing 30, the heat dissipating members 21 are sufficiently pressed against the inner face of the exterior casing 30. Accordingly, the heat that has been conducted from the non-aqueous electrolyte batteries 20 can be conducted efficiently from the heat dissipating members 21 to the exterior casing 30 and the heat can be further released to the outside. Further, with the non-aqueous electrolyte battery module 40, the heat insulating members 22a are disposed between the exterior casing 30 and opposite ends of the battery laminate 25 in the laminating direction thereof, and therefore, the heat dissipation of the non-aqueous electrolyte batteries 20 located at the opposite ends, which constitute the battery laminate 25, does not advance further than the heat dissipation of the other non-aqueous electrolyte batteries 20, making it possible to achieve uniform heat dissipation for the non-aqueous electrolyte batteries 20. Accordingly, it is possible to prevent temperature differences among the non-aqueous electrolyte batteries 20, thus maintaining uniform charge/discharge characteristics of the non-aqueous electrolyte batteries 20.

### Embodiment 2

FIG. 3 is a cross-sectional view showing another mode of the non-aqueous electrolyte battery module of the present invention. The present embodiment is the same as Embodiment 1 except that the bending directions of the bent portions 21a are varied between the upper and lower bent portions 21a. This further improves the positional stability of the battery laminate 25 inside the exterior casing 30 in the laminating direction, thus further improving the earthquake resistance and the like of the non-aqueous electrolyte battery module 40.

### Embodiment 3

FIG. 4 is a cross-sectional view showing yet another mode of the non-aqueous electrolyte battery module of the present invention. The present embodiment is the same as Embodiment 1 except that heat insulating members 22b are further disposed on one face of the heat dissipating members 21. This suppresses the heat conduction among the non-aqueous electrolyte batteries 20, and therefore the heat dissipation for the non-aqueous electrolyte batteries 20 can be performed uniformly. Accordingly, it is possible to prevent temperature differences among the non-aqueous electrolyte batteries 20 in a more reliable manner, thus maintaining uniform charge/discharge characteristics of the non-aqueous electrolyte batteries 20. The heat dissipating members 21 and the heat insulating members 22b may alternately be bonded with an adhesive. In addition, the bending directions of the bent portions 21a may be varied in the present embodiment as well.

While there is no particular limitation with respect to the material of the heat insulating members 22b, the same material as that of the heat insulating members 22a can be used, for example. While there is also no particular limitation with respect to the thickness of the heat insulating members 22b, the thickness can be smaller than that of the heat insulating members 22a, for example.

### Embodiment 4

FIG. 5 is a cross-sectional view showing yet another mode of the non-aqueous electrolyte battery module of the present invention. The present embodiment is the same as Embodiment 1 except that insulating sheets 23 are further disposed on both faces of the heat dissipating members 21. This makes it possible to prevent a short circuit between the exterior casing 30 and the non-aqueous electrolyte batteries 20 in a reliable manner. Although the problem of a short circuit does not arise in normal conditions since the inside and the outside of the non-aqueous electrolyte batteries 20 are insulated from each other. However, a plurality of non-aqueous electrolyte batteries 20 are connected in series and a high potential is thus generated, the exterior casing 30 is at a ground potential in many cases, resulting in a very large potential difference between the exterior casing 30 and the non-aqueous electrolyte batteries 20. However, even in this case, it is possible to prevent a short circuit between the exterior casing 30 and the non-aqueous electrolyte batteries 20 in a reliable manner by disposing the insulating sheet 23 on both faces of the heat dissipating members 21. In addition, the bending directions of the bent portions 21a may be varied in the present embodiment as well.

While there is no particular limitation with respect to the material of the insulating sheet 23 as long as it has high insulation, a thermoplastic resin such as polyethylene and polypropylene can be used, for example. While there is also no particular limitation with respect to the thickness of the insulating sheet 23, too large a thickness results in reduced heat conduction of the heat dissipating member 21. Therefore, the thickness may be about 0.1 to 0.5 mm. Alternatively, the insulating sheets 23 and the heat dissipating members 21 may be bonded to each other with an adhesive and be disposed as an integrated unit.

### Embodiment 5

FIG. 6 is a cross-sectional view showing yet another mode of the non-aqueous electrolyte battery module of the present invention. The present embodiment is substantially the same as Embodiment 1 except that the non-aqueous electrolyte batteries 20 are disposed on both sides of the heat dissipating members 21 to form laminated units 25a each composed of a non-aqueous electrolyte battery 20, a heat dissipating member 21 and a non-aqueous electrolyte battery 20, and the laminated units 25a are further laminated to form a battery laminate 25. This can reduce the number of components, thus producing the non-aqueous electrolyte battery module 40 efficiently.

In addition, the heat dissipating members 21 and the non-aqueous electrolyte batteries 20, as well as the laminated units 25a, are bonded to each other with an adhesive in the present embodiment as well. Furthermore, the bending directions of the bent portions 21a may be varied.

### Embodiment 6

FIG. 7 is a cross-sectional view showing yet another mode of the non-aqueous electrolyte battery module of the present invention. The present embodiment is the same as Embodiment 5 except that heat insulating members 22b are further disposed between the laminated units 25a and that the bending directions of the bent portions 21a are varied between the upper and lower bent portions 21a. This can prevent temperature differences among the non-aqueous electrolyte batteries 20 in a more reliable manner, thus maintaining uniform charge/discharge characteristics of the non-aqueous electrolyte batteries 20. Also, it is possible to further improve the positional stability of the battery laminate 25 inside the exterior casing 30 in the laminating direction, thus further improving the earthquake resistance and the like of the non-aqueous electrolyte battery module 40.

### Embodiment 7

FIG. 8 is a cross-sectional view showing yet another mode of the non-aqueous electrolyte battery module of the present invention. The present embodiment is the same as Embodiment 5 except that insulating sheets 23 are further disposed on both faces of the heat dissipating members 21. This makes it possible to prevent a short circuit between the exterior casing 30 and the non-aqueous electrolyte batteries 20 in a reliable manner. In addition, the bending directions of the bent portions 21a may be varied in the present embodiment as well.

### Embodiment 8

FIG. 9 is a cross-sectional view showing yet another mode of the non-aqueous electrolyte battery module of the present invention. The present embodiment is substantially the same as Embodiment 5 except that the side faces of the exterior casing 30 with which the bent portions 21a of the heat dissipating members 21 come into contact are corrugated. This increases the surface area of the side faces of the exterior casing 30, and therefore the heat dissipation from the exterior casing 30 to the outside is improved. In addition, the bending directions of the bent portions 21a may be varied in the present embodiment as well.

The side faces of the exterior casing 30 can be corrugated in Embodiments 1 to 7 as well.

The invention may be embodied in other forms without departing from the spirit or essential characteristics thereof. The embodiments disclosed in this application are to be considered in all respects as illustrative and not limiting. The scope of the present invention should be construed in view of the appended claims, rather than the foregoing description, and all changes that come within the meaning and range of equivalency of the claims are intended to be embraced therein.

### INDUSTRIAL APPLICABILITY

As described thus far, the present invention can provide a non-aqueous electrolyte battery module having high heat dissipation and exhibiting an excellent heat dissipation balance among batteries. Accordingly, the non-aqueous electrolyte battery module of the present invention can be widely used, for example, as power sources for automobiles and motorcycles, and power sources for moving objects such as robots, each of which has a wide range of possible working temperatures.

### DESCRIPTION OF REFERENCE NUMERALS

10 Electrode assembly
11 Positive electrode
11a Positive electrode lead terminal
12 Negative electrode
12a Negative electrode lead terminal
13 Separator
14 Exterior member
14a First exterior surface
14b Second exterior surface
15 Electrode housing portion
16a Positive electrode lead terminal portion
16b Negative electrode lead terminal portion
17a, 17b, 17c Sealing portion
20 Non-aqueous electrolyte battery
21 Heat dissipating member
21a Bent portion
22a, 22b Heat insulating member
23 Insulating sheet
25 Battery laminate
25a Laminated unit
30 Exterior casing
30a Lid portion
30b Container portion
31 Space
40 Non-aqueous electrolyte battery module

1. A non-aqueous electrolyte battery module comprising: a plurality of non-aqueous electrolyte batteries, a plurality of heat dissipating members, a plurality of heat insulating members, and an exterior casing housing the non-aqueous electrolyte batteries, the heat dissipating members and the heat insulating members,
the non-aqueous electrolyte batteries each comprising a battery element and a flexible exterior member housing the battery element,
the non-aqueous electrolyte batteries being laminated with the heat dissipating members interposed therebetween to form a battery laminate,
ends of the heat dissipating members being in tight pressing contact with an inner face of the exterior casing,
the heat insulating members being disposed between the exterior casing and opposite ends of the battery laminate in a laminating direction thereof

2. The non-aqueous electrolyte battery module according to claim 1,
wherein the exterior casing is formed of metal,
the heat dissipating members are each formed of a metal plate,
the ends of the heat dissipating members include bent portions, and
the bending angle of the bent portions is an obtuse angle.

3. The non-aqueous electrolyte battery module according to claim 1, wherein the non-aqueous electrolyte batteries and the heat dissipating members are alternately laminated.

4. The non-aqueous electrolyte battery module according to claim 2, wherein the bending directions of the bent portions are all the same.

5. The non-aqueous electrolyte battery module according to claim 2, wherein the bending directions of the bent portions are varied.

6. The non-aqueous electrolyte battery module according to claim 1, wherein the heat insulating members are further disposed on one face of the heat dissipating members.

7. The non-aqueous electrolyte battery module according to claim 1, wherein insulating sheets are further disposed on both faces of the heat dissipating members.

8. The non-aqueous electrolyte battery module according to claim 2,
wherein the non-aqueous electrolyte batteries are disposed on both sides of the heat dissipating members to form laminated units each composed of a non-aqueous electrolyte battery, a heat dissipating member and a non-aqueous electrolyte battery, and
the laminated units are further laminated to form the battery laminate.

9. The non-aqueous electrolyte battery module according to claim 8, wherein the bending directions of the bent portions are all the same.

10. The non-aqueous electrolyte battery module according to claim 8, wherein the bending directions of the bent portions are varied.

11. The non-aqueous electrolyte battery module according to claim 8, wherein heat insulating members are further disposed between the laminated units.

12. The non-aqueous electrolyte battery module according to claim 8, wherein insulating sheets are further disposed on both faces of the heat dissipating members.

13. The non-aqueous electrolyte battery module according to claim 1, wherein side faces of the exterior casing with which the ends of the heat dissipating members come into contact are corrugated.

14. The non-aqueous electrolyte battery module according to claim 1, wherein a space between the non-aqueous electrolyte batteries and the exterior casing is filled with resin.
